(19) United States
(12) Patent Application Publication
(10) Pub. No.: US 2011/0157105 A1
(43) Pub. Date: Jun. 30, 2011

(54) ORGANIC LIGHT EMITTING DISPLAY DEVICE

(75) Inventors: Won-Jun CHOE, Yongin-city (KR); Sang-Soo KIM, Yongin-city (KR)

(73) Assignee: SAMSUNG MOBILE DISPLAY CO., LTD., Yongin-city (KR)

(21) Appl. No.: 12/878,864

(22) Filed: Sep. 9, 2010

(30) Foreign Application Priority Data
Dec. 31, 2009 (KR) 10-2009-0135195

(51) Int. Cl. G09G 5/00; G09G 3/30

(52) U.S. Cl. 345/204; 345/76

(57) ABSTRACT

An organic light emitting display device is disclosed. The organic light emitting display device includes: a panel having scan lines and data lines, with pixels positioned at intersection portions of scan lines and data lines, wherein the panel has a generally rectangular shaped display surface with two long sides and two short sides; a scan driver for driving the scan lines; and a data driver for driving the data lines, wherein transistors associated with the pixels pass through a crystallization process, and a laser beam is irradiated onto the panel in a direction parallel with a short sides of the panel in the crystallization process.

### CROSS-REFERENCE TO RELATED APPLICATIONS

This application claims priority to and the benefit of Korean Patent Application No. 10-2009-0135195, filed on Dec. 31, 2009, in the Korean Intellectual Property Office, the entire content of which is incorporated herein by reference.

### BACKGROUND

1. Field

The field relates to an organic light emitting display device, and more particularly, to an organic light emitting display device configured to enhance image quality and save manufacturing cost.

2. Description of the Related Technology

Organic light emitting display devices display images using organic light emitting diodes that emit light through recombination of electrons and holes. Organic light emitting display devices generally have fast response speeds and consume low power.

An organic light emitting device has pixels disposed in a matrix form. Each of the pixels displays an image while controlling the amount of current supplied to an organic light emitting diode in response to a data signal. Each of the pixels is associated with a plurality of transistors.

Each of the transistors generally includes a semiconductor layer having source, drain and channel regions, a gate electrode, a source electrode and a drain electrode. The semiconductor layer is formed of polycrystalline silicon (poly-si) or amorphous silicon (a-si). In some organic light emitting display devices, the polycrystalline silicon is used as a semiconductor layer. Polycrystalline silicon generally exhibits high electron mobility.

The polycrystalline silicon is generally prepared by forming amorphous silicon on a substrate and crystallizing the amorphous silicon. Various methods may be used to crystallize the amorphous silicon. In some crystallization processes, excimer laser annealing (ELA) is used. With ELA, amorphous silicon is crystallized into polycrystalline silicon by irradiating a laser beam onto the amorphous silicon.

The process of crystallizing amorphous silicon into polycrystalline silicon by irradiating a laser beam onto the amorphous silicon affects the characteristics of transistors, such as their mobility and threshold voltage. Therefore, it is generally preferable to use a uniform laser beam to irradiate a plurality of transistors of a device.

FIG. 1 is a view illustrating a display panel.

Referring to FIG. 1, the panel 10 is manufactured to have a long-side portion 4 and a short-side portion 6. The panel 10 has pixels 2 disposed in a matrix form. Here, the pixels 2 are arranged to have a stripe structure. Each of the pixels 2 has a rectangular structure in which sides parallel with the short side portion 6 are set as long sides and sides parallel with the long-side portion 4 are set as short sides.

In the panel 10, transistors associated with the pixels 2 are crystallized by irradiating a laser beam onto the panel 10 in the horizontal direction parallel with the long-side portion 4 of the panel 10 using an ELA crystallization device. For a laser beam used to irradiate the panel 10 in the horizontal direction of the panel 10, the wavelength of the laser beam depends on the length of the long-side portion of the panel 10. For example, in the case of a 55-inch panel, the length of the long-side portion 4 may be 1200 mm, and accordingly, an ELA crystallization device used to irradiate a laser beam may have a wavelength of about 1500 mm. As the horizontal size of the display is increased, the wavelength of the ELA crystallization device is increased, thereby increasing manufacturing costs.

One possible alternative conventionally is to divide a panel 20 into at least two areas as illustrated in FIG. 2, and to irradiate a laser beam on each of the two areas. For example, transistors are crystallized by dividing the panel 20 into left and right areas and irradiating a laser beam onto each of the left and right areas. However, when a laser beam is irradiated onto the panel 20 two or more times, a boundary portion 22 between the left and right areas is irradiated by both laser beams. Therefore, characteristics of transistors positioned at the boundary portion 22 of the panel 20 are affected differently than transistors positioned at the areas outside of the boundary portion 22. Due to these transistors with different characteristics, a stripe-shaped noise may appear at the boundary portion 22 of the display.

### SUMMARY OF CERTAIN INVENTIVE ASPECTS

In one embodiment, there is provided an organic light emitting display device capable of enhancing image quality and saving manufacturing cost.

According to an aspect of the present invention, there is provided an organic light emitting display device, including a panel having scan lines and data lines, with pixels positioned at intersection portions of scan lines and data lines, where the panel has a generally rectangular shape display surface with two long sides and two short sides, a scan driver for driving the scan lines and a data driver for driving the data lines, wherein transistors included in the pixels pass through a crystallization process, and a laser beam is irradiated onto the panel in a direction parallel with the short sides of the panel in the crystallization process.

The pixels may have a rectangular shape, and short sides of the pixels are arranged in parallel with the short sides of the panel. The scan lines may be formed in a direction parallel with the short sides of the panel, and the data lines may be formed in a direction parallel with the long sides of the panel. The organic light emitting display device may further include a timing controller for controlling the scan driver and the data driver, a frame memory for storing data supplied from the exterior of the organic light emitting display device, and a converter for providing the data stored in the frame memory to the timing controller while controlling the supply order of the data. The converter may control the supply order so that the data are supplied in direction parallel to the short sides of the panel.

In an organic light emitting display device according to an embodiment of the present invention, a laser beam is irradiated onto a panel in the vertical direction of the panel in a crystallization process, thereby saving manufacturing cost. Further, a laser beam is irradiated on the panel at one time without dividing the panel into areas, thereby ensuring uniformity of transistors. Furthermore, pixels are arranged to have a stripe structure in the horizontal direction of the panel, thereby decreasing the number of data lines. Accordingly, manufacturing cost can be saved.

According to another aspect, an organic light emitting display device is disclosed, including: a panel having a generally rectangular shaped display surface with two long sides and two short sides when viewed in a direction perpendicular to the display surface, the panel including an array of pixels, a plurality of transistors associated with the pixels, where each transistor includes an elongated active layer strip elongated generally along the long sides of the panel. The length of the long sides of the panel may exceed 1200 mm. The active layer strips of the transistors may be crystallized by scanning a laser beam onto the strips in a direction generally parallel with the long sides of the panel. The laser beam may include a wavelength of about 690 mm or shorter. The pixels may be positioned at intersection points of scan lines and data lines, where the scan lines extend in a direction generally parallel to the short sides of the panel and the data lines extend in a direction generally parallel to the long sides of the panel. The display device may further include: a scan driver configured to drive the scan lines, a data driver configured to drive the data lines, a timing controller configured to control the scan driver and the data driver, a converter configured to convert a supply order of data received from the exterior of the organic light emitting display device and to provide the converted supply order of data to the timing controller. Converting the supply order of data received from the exterior of the organic light emitting display device may include changing the order of the data such that the data is supplied in the direction generally parallel to the long sides of the panel via the scan lines of the device.

According to another aspect, a method of operating an organic light emitting display device is disclosed. The method includes: providing an organic light emitting display device as disclosed in one aspect above, and supplying data from the data driver to the pixels in a direction generally parallel to the long sides of the panel. The method may also include: converting a supply order of data received from the exterior of the device; and providing the converted supply order of data to the timing controller. Converting the supply order of data from the exterior may include changing the order of the data such that the data is supplied in the direction of the long sides of the panel.

According to another aspect, a method of manufacturing an organic light emitting display device is disclosed. The method includes: providing a substrate in a generally rectangular shape with two long sides and two short sides, fabricating a plurality of strips including a semiconductive material over the substrate, each strip elongated in a direction generally parallel with the long sides of the substrate, applying a laser beam to the semiconductive material of the plurality of strips to at least partly crystallize the semiconductive material, where applying the laser beam includes scanning the laser beam in a direction generally parallel with the long sides of the substrate. None of the strips may be double scanned by the laser beam for crystallizing the semiconductive material. The laser beam may include a wavelength of about 690 mm or shorter.

### BRIEF DESCRIPTION OF THE DRAWINGS

The accompanying drawings, together with the specification, illustrate exemplary embodiments of the present invention.

FIG. 1 is illustrates a top view of a panel.

FIG. 2 is illustrates a crystallization process of the panel illustrated in FIG. 1.

FIG. 3 illustrates a top view of an embodiment of a panel.

FIG. 4 illustrates an embodiment of a crystallization process applied to the panel illustrated in FIG. 4.

FIG. 5 is a block diagram of an embodiment of an organic light emitting display device including the panel illustrated in FIG. 3.

FIGS. 6A and 6B are views illustrating scanning orders used with an embodiment of an organic light emitting display device including the panel illustrated in FIG. 3.

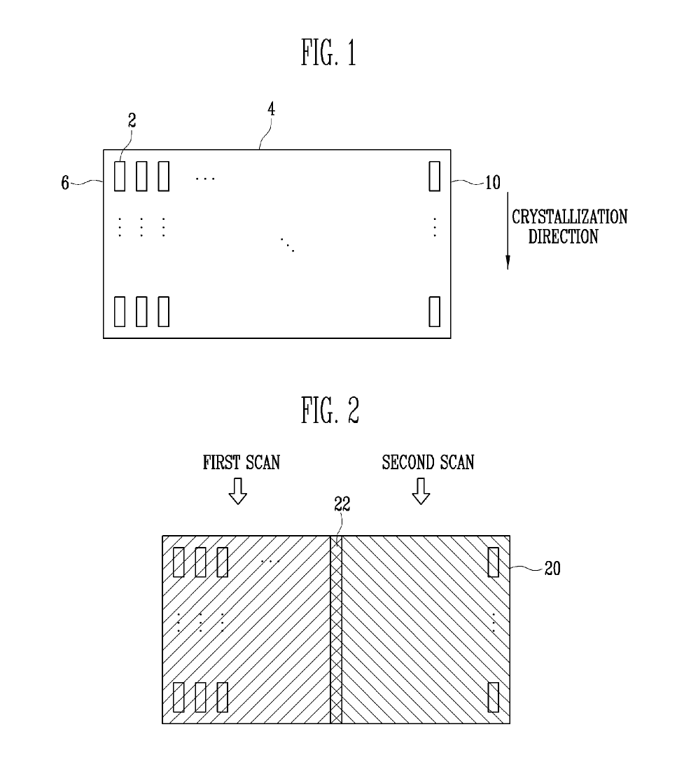

### DETAILED DESCRIPTION OF CERTAIN INVENTIVE EMBODIMENTS

In the following detailed description, certain exemplary embodiments of the present invention have been shown and described, by way of illustration. As those skilled in the art would realize, the described embodiments may be modified in various ways, without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals generally refer to like elements.

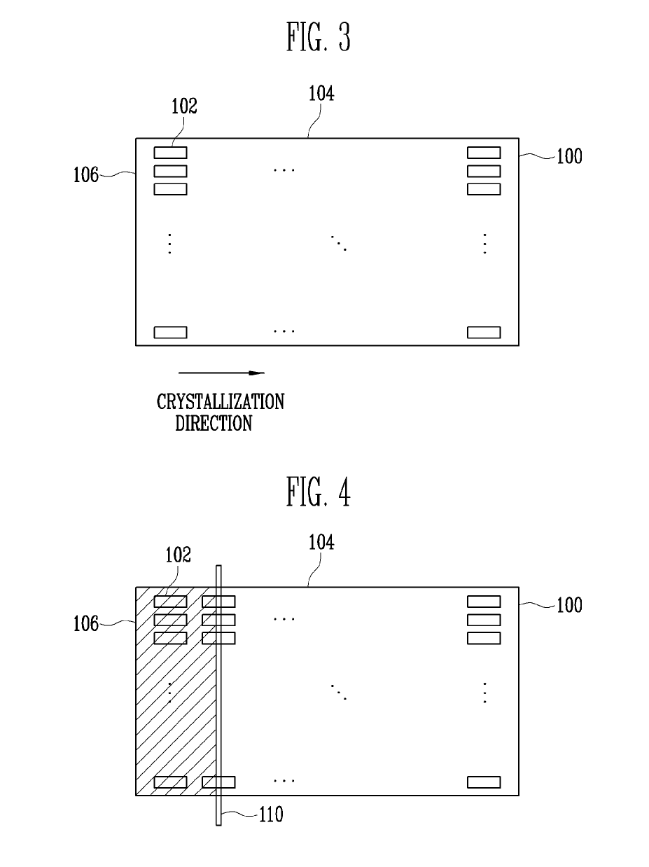

FIG. 3 illustrates a top view of an embodiment of a panel.

As illustrated in FIG. 3, an embodiment of a panel 100 includes an array of pixels 102 arranged in a matrix form. One embodiment of the panel 100 may be of a rectangular shape with long-side portions 104 and short-side portions 106. The pixels 102 may be arranged to have a stripe structure in the horizontal direction of the panel 100. In one embodiment, each of the pixels 102 may have a rectangular shape, arranged with short sides parallel with the short-side portions 106 of the panel 100, and long sides parallel with the long-side portions 104 of the panel 100.

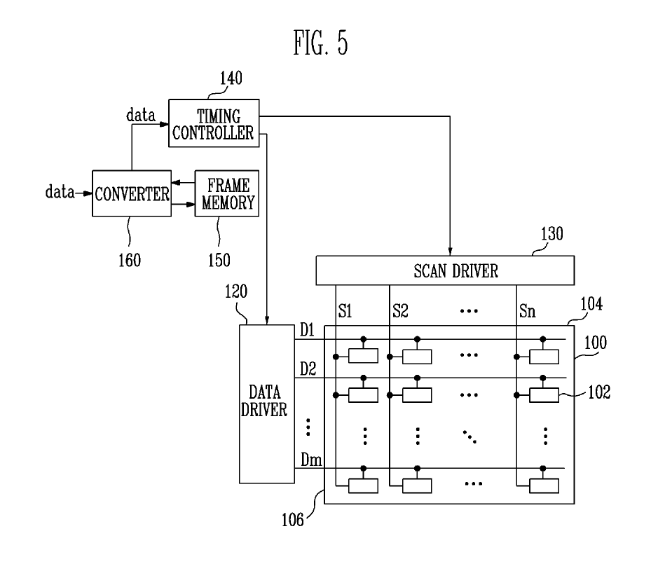

In the array of pixels 102 described above, each of the pixels is associated with a plurality of transistors. With the pixels 102 arranged with long and short-sided portions to be parallel with the long and short-sided portions of the panel 100, associated transistors are also arranged in the same way. Therefore, the transistors associated with the pixels 102 may be crystallized with a laser beam irradiated onto the panel 100 in parallel with the short-side portion 106 of the panel 100, as illustrated in FIG. 4. A laser beam 110 is irradiated onto the panel 100 in the vertical direction of the panel 100.

The length of the irradiated laser beam 110 in such an embodiment may be determined by the length of the short-side portion 106 of the panel 100. Therefore, the wavelength of the laser beam in one embodiment is smaller than the wavelength of a laser beam irradiated in horizontal direction of the panel 100, and manufacturing costs are thereby reduced. For example, in the case of a 55-inch panel, the ELA device used for irradiating the laser beam may have a wavelength of about 690 mm. The reduced wavelength also enables the use of one-time scanning for crystallization. The one-time scanning reduces the difference in transistor characteristics created by a multiple scanning process, where a boundary area of multiple irradiation may be created. Uniform transistor characteristics helps enhance image quality.

FIG. 5 is a block diagram of an embodiment of an organic light emitting display device including the panel illustrated in FIG. 3.

Referring to FIG. 5, an organic light emitting display device according to one embodiment includes a panel 100 having pixels 102. An embodiment of an organic light emitting display device may include a data driver 120 for driving data lines D1 to Dm and a scan driver 130 for driving scan lines S1 to Sn. The pixels 102 may be positioned at intersection portions of the data lines D1 to Dm and the scan lines S1 to Sn. The embodiment of the organic light emitting display device may also include a frame memory 150 for storing data supplied from the exterior of the organic light emitting display device for each frame; a converter 160 for providing data to a timing controller 140 while controlling the supply order of the data stored in the frame memory 150; and a timing controller 140 for controlling the scan driver 130 and the data driver 120.

In one embodiment, the array of pixels 102 may be arranged to have a stripe structure, with the long sides of the pixels 102 in parallel with the long-side portions 104 of the panel 100 and short sides of the pixels 102 in parallel with the short-side portions 106 of the panel 100. The data lines D1 to Dm may also be formed in the horizontal direction (i.e., in parallel with the long-side portions 104 of the panel). The scan lines S1 to Sn may be formed in the vertical direction of the panel 100 (i.e., in parallel with the short-side portions 106 of the panel 100).

In conventional organic light emitting display device panels, data lines are generally formed in the vertical direction. In an embodiment with the data lines D1 to Dm formed in the horizontal direction of the panel 100, the number of the data lines D1 to Dm is reduced. The reduction of data lines helps further reduce manufacturing costs. For example, in a conventional organic light emitting display device providing full HD (FHD) resolution, eight integrated circuits (ICs) with 720 channels might be included in a data driver, so as to provide 1920×3 channels. In an embodiment of an organic light emitting display device, four ICs with 810 channels may be included in the data driver 120, so as to provide 1080×3 channels. The manufacturing costs are reduced by the use of a lower number of integrated circuits.

Returning to FIG. 5, the scan driver 130 sequentially supplies a scan signal to the scan lines S1 to Sn. When a scan signal is provided to one of the scan lines S1 to Sn, the pixels 102 of the respective vertical line are selected. The data driver 120 supplies a data signal to the data lines D1 to Dm in synchronization with the scan signal. A data signal is supplied to the line of selected pixels 102.

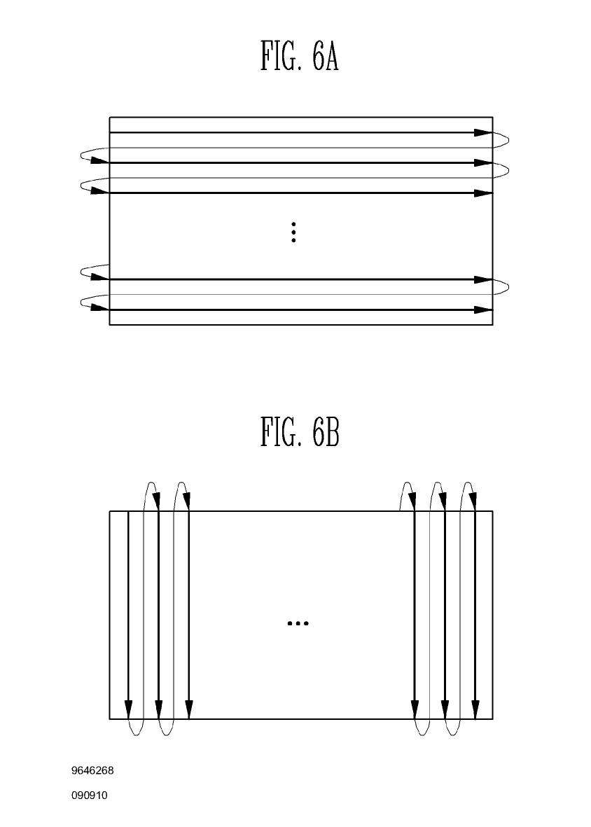

The converter 160 stores data supplied from the exterior of the organic light emitting display device in the frame memory 150, and provides the data stored in the frame memory 150 to the timing controller 140. The converter 160 also controls the supply order of the data. The supply order of the data supplied from the exterior of the organic light emitting display device is determined to ensure that the data is supplied by the horizontal data lines D1 through Dm. This supply order is illustrated in FIG. 6A.

However, since a data signal is supplied only to the vertical line of pixels selected by a scan line, supplying of data sequentially in the order of the horizontal lines will not display a desired image. Accordingly, the converter 160 is configured to change the supply order of the data so that the data is sequentially supplied by the vertical lines, as illustrated in FIG. 6B. The data controller provides the data with the modified supply order to the timing controller 140. The timing controller 140 provides the data supplied from the converter 160 to the data driver 120.

In some embodiments, the converter 160 and the timing controller 140 are distinct from one another. In other embodiments, the converter 160 may be incorporated within the timing controller 140.

While the present invention has been described in connection with certain exemplary embodiments, it is to be understood that the invention is not limited to the disclosed embodiments, but, on the contrary, is intended to cover various modifications and equivalent arrangements.

What is claimed is:

1. An organic light emitting display device, comprising:
a panel having scan lines and data lines, with pixels positioned at intersection portions of scan lines and data lines, wherein the panel has a generally rectangular shaped display surface with two long sides and two short sides;
a scan driver for driving the scan lines; and
a data driver for driving the data lines;
wherein transistors associated with the pixels pass through a crystallization process, and a laser beam is irradiated onto the panel in a direction parallel with a short sides of the panel in the crystallization process.

2. The organic light emitting display device according to claim 1, wherein the pixels have a rectangular shape, and short sides of the pixels are arranged in parallel with the short sides of the panel.

3. The organic light emitting display device according to claim 2, wherein the scan lines are formed in a direction parallel with the short sides of the panel, and the data lines are formed in a direction parallel with the long sides of the panel.

4. The organic light emitting display device according to claim 1, further comprising:
a timing controller for controlling the scan driver and the data driver;
a frame memory for storing data supplied from the exterior of the organic light emitting display device; and
a converter for providing the data stored in the frame memory to the timing controller while controlling the supply order of the data.

5. The organic light emitting display device according to claim 4, wherein the converter controls the supply order so that the data are supplied in a direction parallel to the short sides of the panel.

6. An organic light emitting display device, comprising:
a panel having a generally rectangular shaped display surface with two long sides and two short sides when viewed in a direction perpendicular to the display surface, the panel comprising an array of pixels;
a plurality of transistors associated with the pixels, wherein each transistor comprises an elongated active layer strip elongated generally along the long sides of the panel.

7. The device of claim 6, wherein the length of the long sides of the panel exceeds 1200 mm.

8. The device of claim 6, wherein the active layer strips of the transistors are crystallized by scanning a laser beam onto the strips in a direction generally parallel with the long sides of the panel.

9. The device of claim 6, wherein the laser beam comprises a wavelength of about 690 mm or shorter.

10. The device of claim 6, wherein the pixels are positioned at intersection points of scan lines and data lines, wherein the scan lines extend in a direction generally parallel to the short sides of the panel and the data lines extend in a direction generally parallel to the long sides of the panel.
